(19) United States
(12) Patent Application Publication
(10) Pub. No.: US 2020/0019025 A1
(43) Pub. Date: Jan. 16, 2020

(54) LIQUID CRYSTAL DISPLAY PANEL

(71) Applicant: SHENZHEN CHINA STAR OPTOELECTRONICS SEMICONDUCTOR DISPLAY TECHNOLOGY CO., LTD, Shenzhen (CN)

(72) Inventor: Yanxi YE, Shenzhen (CN)

(21) Appl. No.: 16/204,032

(22) Filed: Nov. 29, 2018

Related U.S. Application Data
(63) Continuation of application No. PCT/CN2018/104466, filed on Sep. 7, 2018.

(30) Foreign Application Priority Data
Jul. 13, 2018 (CN) 201810768950.7

(51) Int. Cl. G02F 1/1343; G02F 1/1362; G02F 1/1335

(52) U.S. Cl. CPC G02F 1/134309; G02F 1/136286; G02F 2001/133357; G02F 1/133514; G02F 2201/121; G02F 1/133512

(57) ABSTRACT

A liquid crystal display panel is provided. The panel includes an array substrate; a passivation layer disposed on the array substrate; and a planarization layer disposed on the passivation layer; wherein the planarization layer is provided with multiple first common electrodes, and the array substrate is provided with a second common electrode for shielding light, and the second common electrode is located at an edge location of an active area region of the liquid crystal display panel, the second common electrode extends to an inner side and/or an outer side of the active area region, and an outermost first common electrode of the multiple first common electrodes and the second common electrode are electrically connected. The invention provides a liquid crystal display panel, which can solve the problem of light leakage at the edge of the active area region of the liquid crystal display panel.

### CROSS-REFERENCE TO RELATED APPLICATION

This application is a continuing application of PCT Patent Application No. PCT/CN2018/104466, entitled “LIQUID CRYSTAL DISPLAY PANEL”, filed on Sep. 7, 2018, which claims priority to China Patent Application No. 201810768950.7 filed on Jul. 13, 2018, both of which are hereby incorporated in its entireties by reference.

### FIELD OF THE INVENTION

The present invention relates to a display technology field, and more particularly to a liquid crystal display panel.

### BACKGROUND OF THE INVENTION

The BPS (Black photo spacer) technology is a technology that combines two processes of BM (black matrix) and PS (gap control) into one process of LCD (Liquid Crystal Display) technology. The BPS process realized in the array substrate can enable the sharing of the flat panel and the curved panel. The BPS process realized in the array substrate is an important design point for the design of the AA (active area) region and the periphery of the AA region of the display panel.

The design of the normal BPS technology at the junction of the periphery and the AA region is shown in FIG. 1. In FIG. 1, 11′ is a glass substrate, 12′ is a gate insulation layer, 13′ is a data line, and 14′ is a metal common electrode, 2′ is a passivation layer, 3′ is a planarization layer, 4′ is a color resist layer, 5′ is an ITO (Indium tin oxide) common electrode, 6′ is a pixel electrode, and 7′ is a BPS material layer. Since the height of the BPS material layer is generally about 3.5 um, at the boundary of the BPS material layer, since the boundary of the BPS material layer and the AA region has a high topographical difference, the liquid crystal is at the boundary between the AA region and the BPS material layer. The liquid crystal stands at the junction of the AA region and the BPS material layer with the downhill topography of the BPS material layer, rather than standing regularly.

In the case of applying a voltage, the liquid crystal has a certain pre-tilt angle, and the tilting direction is affected by the pre-tilt angle, and does not tilt as expected. Therefore, light leakage is likely to occur at the boundary between the AA region and the BPS material layer. As shown in FIG. 1, the intersection of the AA region and the BPS material layer is provided with the data line and the ITO common electrode. The data line is opaque metal and can be used as a light shading effect. The ITO common electrode and the oppositely disposed upper substrate common electrode are equipotential, and the electric field formed is an electric field having no potential energy, so the liquid crystal is not stressed.

However, the region between the data line and the metal common electrode and the peripheral region of the active area region are free from metal shading. The region between the ITO common electrode and the common electrode of the upper substrate is still subject to the voltage difference of the electric field caused by interference of other electrodes such as data lines, scan lines or pixel electrodes. In addition, due to the high topographical difference between the BPS material layer boundary and the AA region, the liquid crystal has a large and irregular pre-tilt angle, and there is still a large risk of light leakage.

### SUMMARY OF THE INVENTION

In order to solve the above technical problem, the present invention provides a liquid crystal display panel, which can solve the problem of light leakage at the edge of the active area region of the liquid crystal display panel.

The present invention provides a liquid crystal display panel, comprising: an array substrate; a passivation layer disposed on the array substrate; and a planarization layer disposed on the passivation layer; wherein the planarization layer is provided with multiple first common electrodes, and the array substrate is provided with a second common electrode for shielding light, and the second common electrode is located at an edge location of an active area region of the liquid crystal display panel, the second common electrode extends to an inner side and/or an outer side of the active area region, and an outermost first common electrode of the multiple first common electrodes and the second common electrode are electrically connected.

Wherein the array substrate includes a glass substrate and a gate insulation layer and the second common electrode on the glass substrate, the gate insulation layer covers the second common electrode; and multiple data lines are disposed on the gate insulation layer, and the passivation layer covers the multiple data lines; an outermost data line of the multiple data lines are located at the edge location of the active area region; and wherein the liquid crystal display panel further includes an upper substrate common electrode disposed opposite to the first common electrode, and a liquid crystal is sandwiched between the upper substrate common electrode and the first common electrode.

Wherein the second common electrode is disposed below the outermost data line, a projection of the outermost data line on the glass substrate is a first projection, and a projection of the second common electrode below the outermost data line on the glass substrate is a second projection, the first projection is partially overlapped with the second projection portion in a width direction of the first projection, or the first projection is entirely inside the second projection in the width direction of the first projection.

Wherein the array substrate is provided with multiple scanning lines, and the liquid crystal display panel includes multiple second common electrodes; two opposite second common electrodes are disposed between adjacent two scanning lines; the second common electrode between the adjacent two scanning lines is located below the outermost data line; and in the array substrate, outermost of the multiple scanning lines is provided with two second common electrodes, a region surrounded by the multiple second common electrodes surrounds the active area region; wherein the second common electrode and the scanning line are insulated from each other.

Wherein the first common electrode is an ITO electrode, and the second common electrode and the data line are both opaque metal electrodes.

Wherein the liquid crystal display panel further includes a color resist layer, and the color resist layer is sandwiched between the passivation layer and the planarization layer; wherein a via hole is formed in the planarization layer and the passivation layer, and the color resist layer and the via hole is further staggered with the data line, and the outermost first common electrode is electrically connected to the second common electrode through the via hole.

Wherein the liquid crystal display panel further includes a BPS material layer, and the BPS material layer is located on the planarization layer and covering at least a portion of the first common electrode.

The present invention further provides a liquid crystal display panel, comprising: an array substrate; a passivation layer disposed on the array substrate; and a planarization layer disposed on the passivation layer wherein the planarization layer is provided with multiple first common electrodes, and the array substrate is provided with a second common electrode for shielding light, and the second common electrode is located at an edge location of an active area region of the liquid crystal display panel, the second common electrode extends to an inner side and/or an outer side of the active area region, and an outermost first common electrode of the multiple first common electrodes and the second common electrode are electrically connected; wherein the array substrate includes a glass substrate and a gate insulation layer and the second common electrode on the glass substrate, the gate insulation layer covers the second common electrode; and multiple data lines are disposed on the gate insulation layer, and the passivation layer covers the multiple data lines; an outermost data line of the multiple data lines are located at the edge location of the active area region; wherein the liquid crystal display panel further includes an upper substrate common electrode disposed opposite to the first common electrode, and a liquid crystal is sandwiched between the upper substrate common electrode and the first common electrode; wherein the liquid crystal display panel further includes a color resist layer, and the color resist layer is sandwiched between the passivation layer and the planarization layer; and wherein a via hole is formed in the planarization layer and the passivation layer, and the via hole is further staggered with the data line, and the outermost first common electrode is electrically connected to the second common electrode through the via hole.

Wherein the second common electrode is disposed below the outermost data line, a projection of the outermost data line on the glass substrate is a first projection, and a projection of the second common electrode below the outermost data line on the glass substrate is a second projection, the first projection is partially overlapped with the second projection portion in a width direction of the first projection, or the first projection is entirely inside the second projection in the width direction of the first projection.

Wherein the array substrate is provided with multiple scanning lines, and the liquid crystal display panel includes multiple second common electrodes; two opposite second common electrodes are disposed between adjacent two scanning lines; the second common electrode between the adjacent two scanning lines is located below the outermost data line; and in the array substrate, outermost of the multiple scanning lines is provided with two second common electrodes, a region surrounded by the multiple second common electrodes surrounds the active area region; wherein the second common electrode and the scanning line are insulated from each other.

Wherein the first common electrode is an ITO electrode, and the second common electrode and the data line are both opaque metal electrodes.

Wherein the liquid crystal display panel further includes a BPS material layer, and the BPS material layer is located on the planarization layer and covering at least a portion of the first common electrode.

The present invention further provides a liquid crystal display panel, comprising: an array substrate; a passivation layer disposed on the array substrate; and a planarization layer disposed on the passivation layer; wherein the planarization layer is provided with multiple first common electrodes, and the array substrate is provided with a second common electrode for shielding light, and the second common electrode is located at an edge location of an active area region of the liquid crystal display panel, the second common electrode extends to an inner side and/or an outer side of the active area region, and an outermost first common electrode of the multiple first common electrodes and the second common electrode are electrically connected; wherein the liquid crystal display panel further includes a color resist layer and a BPS material layer; wherein the liquid crystal display panel further includes a color resist layer, and the color resist layer is sandwiched between the passivation layer and the planarization layer; wherein a via hole is formed in the planarization layer and the passivation layer, and the via hole is further staggered with the data line, and the outermost first common electrode is electrically connected to the second common electrode through the via hole; and wherein the BPS material layer is located on the planarization layer and covering at least a portion of the first common electrode.

Wherein the array substrate includes a glass substrate and a gate insulation layer and the second common electrode on the glass substrate, the gate insulation layer covers the second common electrode; and multiple data lines are disposed on the gate insulation layer, and the passivation layer covers the multiple data lines; an outermost data line of the multiple data lines are located at the edge location of the active area region; and wherein the liquid crystal display panel further includes an upper substrate common electrode disposed opposite to the first common electrode, and a liquid crystal is sandwiched between the upper substrate common electrode and the first common electrode.

Wherein the second common electrode is disposed below the outermost data line, a projection of the outermost data line on the glass substrate is a first projection, and a projection of the second common electrode below the outermost data line on the glass substrate is a second projection, the first projection is partially overlapped with the second projection portion in a width direction of the first projection, or the first projection is entirely inside the second projection in the width direction of the first projection.

Wherein the array substrate is provided with multiple scanning lines, and the liquid crystal display panel includes multiple second common electrodes; two opposite second common electrodes are disposed between adjacent two scanning lines; the second common electrode between the adjacent two scanning lines is located below the outermost data line; and in the array substrate, outermost of the multiple scanning lines is provided with two second common electrodes, a region surrounded by the multiple second common electrodes surrounds the active area region; wherein the second common electrode and the scanning line are insulated from each other.

Wherein the first common electrode is an ITO electrode, and the second common electrode and the data line are both opaque metal electrodes.

The invention has the following beneficial effects: the liquid crystal display panel provided by the present invention has a second common electrode for shielding light at the edge of the corresponding active area region on the array substrate, and the second common electrode is extended to an inner side and/or an outer side of the active area region, which can block light leakage at the edge of the active area region. Moreover, the second common electrode is also electrically connected to the first common electrode, and the common voltage signal of the first common electrode can be enhanced, thereby enhancing the field energy between the first common electrode and the upper substrate common electrode. The influence of the remaining electrodes on the electric field between the first common electrode and the upper substrate common electrode is shielded, so that the liquid crystal between the first common electrode and the upper substrate common electrode does not randomly rotate, which can also avoid the light leakage.

### BRIEF DESCRIPTION OF THE DRAWINGS

In order to more clearly illustrate the embodiments of the present invention or the technical solutions in the prior art, the drawings used in the embodiments or the prior art description will be briefly introduced below. Obviously, the drawings in the following description are only some embodiments of the present invention. For those of ordinary skill in the art, without creative labor, other drawings can also be obtained from these figures.

FIG. 1 is a schematic structural view of an active area region of a liquid crystal display panel and a peripheral region in the prior art.

FIG. 2 is a schematic structural view of an active area region of a liquid crystal display panel and a peripheral region in the first embodiment provided by the present invention.

FIG. 3 is a schematic structural view of an active area region of a liquid crystal display panel and a peripheral region in the second embodiment provided by the present invention.

FIG. 4 is a schematic view showing the formation of the via hole in the passivation layer and the planarization layer of the liquid crystal display panel in the first embodiment provided by the present invention.

FIG. 5 is a schematic diagram of a second common electrode between adjacent two scanning lines provided by the present invention.

FIG. 6 is a schematic diagram showing the distribution of multiple second common electrodes provided by the present invention.

### DETAILED DESCRIPTION OF PREFERRED EMBODIMENTS

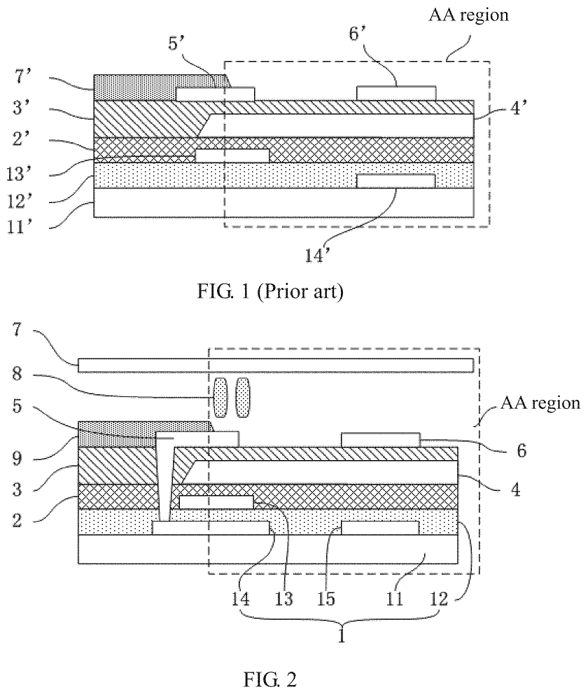

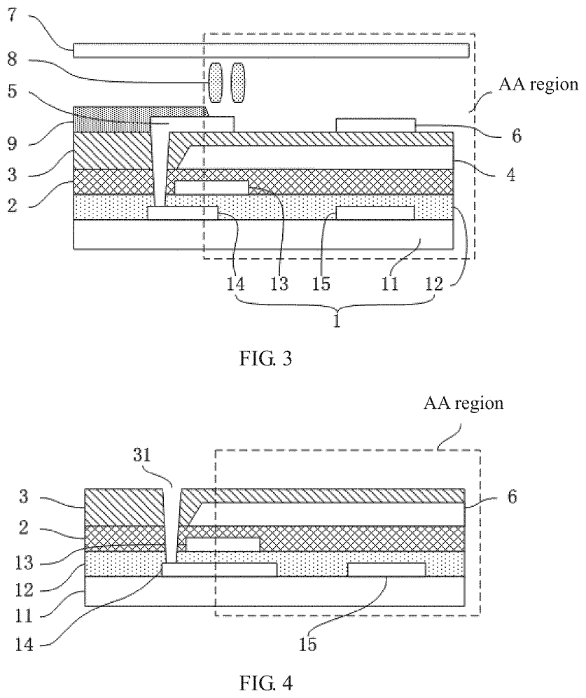

The present invention provides a liquid crystal display panel, as shown in FIG. 2 or FIG. 3, the liquid crystal display panel includes: an array substrate 1, a passivation layer 2 on the array substrate 1, and a planarization layer 3 on the passivation layer 2.

The planarization layer 3 is provided with multiple linear first common electrodes, and the array substrate 1 is provided with a second common electrode 14 for shielding light, and the second common electrode 14 is located at an edge location of an active area region (AA region) of the liquid crystal display panel. Besides, the second common electrode 14 extends to an inner side and/or an outer side of the active area region, and an outermost first common electrode 5 of the multiple first common electrodes and the second common electrode 14 are electrically connected.

Since the light leakage is likely to occur around the active area region of the liquid crystal display panel, disposing the second common electrode 14 that can be shielded from light at the edge of the active area region can block the light leakage.

Further, the array substrate 1 includes a glass substrate 11 and a gate insulation layer 12 and the second common electrode 14 on the glass substrate 11. The gate insulation layer 12 covers the second common electrode 14; and multiple data lines are disposed on the gate insulation layer 12, and the passivation layer 2 covers the multiple data lines; an outermost data line 13 of the multiple data lines are located at the edge location of the active area region.

The liquid crystal display panel further includes an upper substrate common electrode 7 disposed opposite to the first common electrode 5, and a liquid crystal 8 is sandwiched between the upper substrate common electrode 7 and the first common electrode 5.

The second common electrode 14 and the first common electrode 5 are both inputted with common voltage signals transmitted from the external circuit, and electrically connecting the first common electrode 5 and the second common electrode 14 is equivalent to connect the first common electrode 5 and the second common electrodes 14 in parallel to the external circuit, so that the resistance of the entire circuit can be reduced, so that the common voltage signal connected to the first common electrode 5 and the second common electrode 14 is enhanced.

In generally, the array substrate 1 serves as a lower substrate, and an upper substrate (for example, a color filter substrate) opposite to the array substrate 1 is also provided with a common electrode, and an upper substrate common electrode 7 is disposed oppositely to the first common electrode 5, and a liquid crystal 8 is disposed between the upper substrate the common electrode 7 and the first common electrode 5. When the common voltage signal connected to the first common electrode 5 is enhanced, a stronger field energy can be generated between the common electrode 5 and the upper substrate common electrode 7 such that the influence of the remaining electrodes (for example, nearby pixel electrodes) on the electric field between the first common electrode 5 and the upper substrate common electrode 7 is shielded, so that the liquid crystal 8 between the first common electrode 5 and the upper substrate common electrode 7 does not rotate randomly. In this case, the light leakage is avoided.

Of course, there is also a third common electrode 15 on the glass substrate 11, and the second common electrode 14 and the third common electrode 15 are made of a same layer of metal. The number of the third common electrodes 15 may be multiple, and each of the third common electrodes 15 corresponds to one sub-pixel in the active area region. A storage capacitor is formed between each of the third common electrodes 15 and the pixel electrodes 6 in each of the sub-pixels.

The first common electrode 5 is an ITO (Indium Tin Oxide) electrode, and the second common electrode 14, the third common electrode 15, and the data line 13 are all opaque metal electrodes.

The liquid crystal display panel further includes a color resist layer 4, and the color resist layer 4 is sandwiched between the passivation layer 2 and the planarization layer 3.

As shown in FIG. 4, a via hole 31 is formed in the planarization layer 3 and the passivation layer 2, and the via hole 31 also penetrates the gate insulation layer 12, and the via hole 31 is located outside the color resist layer 4 and the via hole 31 is further staggered with the data line 13, and the outermost first common electrode 5 is electrically connected to the second common electrode 14 through the via hole 31.

The liquid crystal display panel further includes a BPS (Black Photo Spacer) material layer 9. The BPS material layer 9 is located on the planarization layer 3 and covering at least a portion of the first common electrode 5.

The second common electrode 14 is disposed below the outermost data line 13, a projection of the outermost data line 13 on the glass substrate 11 is set as a first projection, and a projection of the second common electrode 14 below the outermost data line 13 on the glass substrate 11 is set as a second projection, the first projection is partially overlapped with the second projection portion in a width direction of the first projection, or the first projection is entirely inside the second projection in the width direction of the first projection.

Specifically, as shown in FIG. 2, the first projection are all located inside the second projection in the width direction of the first projection, that is, the width of the second common electrode 14 is greater than the width of the data line 13, and the second common electrode 14 may block the light leakage on both sides of the outermost data line 13.

As shown in FIG. 3, the first projection is partially overlapped with the second projection portion in the width direction of the first projection, and the second common electrode 14 extends outward on the left side of the outermost data line 13, so as to block the light leakage on the left side of the outermost data line 13. Of course, the second common electrode 14 may also extend toward the active area region on the right side of the outermost data line 13, and may block the light leakage on the right side of the outermost data line 13. Since the data line 13 is generally a metal wire which is not transparent, light shielding can be performed. If the left side of the outermost data line 13 is easy to leak light, the second common electrode 14 extends outward on the left side of the outermost data line 13; when the right side of the outer data line 13 is easily to leak light, the second common electrode 14 extends toward the active area region on the right side of the outermost data line 13.

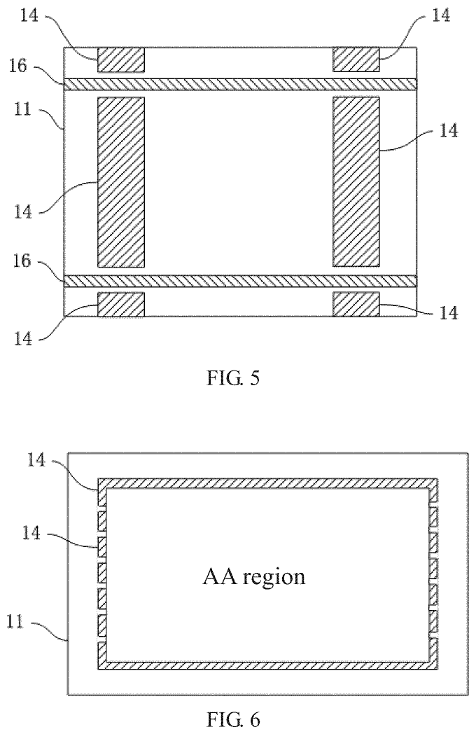

Furthermore, the array substrate 1 is provided with multiple scanning lines, and the liquid crystal display panel includes multiple second common electrodes 14. As shown in FIG. 5, two opposite second common electrodes 14 are disposed between adjacent two scanning lines 16. The second common electrode 14 between the adjacent two scanning lines 16 is located below the outermost data line 13; and in the array substrate 1, outermost of the multiple scanning lines (i.e., all of scanning lines of the array substrate 1) is provided with two second common electrodes 14. As shown in FIG. 6, a region surrounded by the multiple second common electrodes 14 surrounds the active area region (AA region); wherein the second common electrode 14 and the scanning line 16 are insulated from each other. The scanning line 16 is made of opaque metal and can also be used for shading.

In summary, the liquid crystal display panel provided by the present invention has a second common electrode 14 for shielding light at the edge of the corresponding active area region on the array substrate 1, and the second common electrode 14 is extended to an inner side and/or an outer side of the active area region, which can block light leakage at the edge of the active area region. Moreover, the second common electrode 14 is also electrically connected to the first common electrode 5, and the common voltage signal of the first common electrode 5 can be enhanced, thereby enhancing the field energy between the first common electrode 5 and the upper substrate common electrode 7. The influence of the remaining electrodes on the electric field between the first common electrode 5 and the upper substrate common electrode 7 is shielded, so that the liquid crystal 8 between the first common electrode 5 and the upper substrate common electrode 7 does not randomly rotate, which can also avoid the light leakage.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

1: A liquid crystal display panel, comprising:
an array substrate;
a passivation layer disposed on the array substrate; and
a planarization layer disposed on the passivation layer;
wherein the planarization layer is provided with multiple first common electrodes, and the array substrate is provided with a second common electrode for shielding light, and the second common electrode is located at an edge location of an active area region of the liquid crystal display panel, the second common electrode extends to an inner side and/or an outer side of the active area region, and an outermost first common electrode of the multiple first common electrodes and the second common electrode are electrically connected;
wherein the array substrate includes a glass substrate and a gate insulation layer and the second common electrode on the glass substrate, the gate insulation layer covers the second common electrode; and multiple data lines are disposed on the gate insulation layer, and the passivation layer covers the multiple data lines; an outermost data line of the multiple data lines is located at the edge location of the active area region;
wherein the second common electrode that shields light is located below the outermost data line and the outermost first common electrode that transmits light is located above the outermost data line such that the second common electrode that shields light and the outermost first common electrode that transmits light are respectively located at two opposite sides of the outermost data line.

2: The liquid crystal display panel according to claim 1,
wherein the liquid crystal display panel further includes an upper substrate common electrode disposed opposite to the first common electrode, and a liquid crystal is sandwiched between the upper substrate common electrode and the first common electrode.

3: The liquid crystal display panel according to claim 2, wherein a projection of the outermost data line on the glass substrate is a first projection, and a projection of the second common electrode below the outermost data line on the glass substrate is a second projection, the first projection is partially overlapped with the second projection portion in a width direction of the first projection, or the first projection is entirely inside the second projection in the width direction of the first projection.

4: The liquid crystal display panel according to claim 3, wherein the array substrate is provided with multiple scanning lines, and the liquid crystal display panel includes multiple second common electrodes; two opposite second common electrodes are disposed between adjacent two scanning lines; the second common electrode between the adjacent two scanning lines is located below the outermost data line; and in the array substrate, outermost of the multiple scanning lines is provided with two second common electrodes, a region surrounded by the multiple second common electrodes surrounds the active area region; wherein the second common electrode and the scanning line are insulated from each other.

5: The liquid crystal display panel according to claim 3, wherein the first common electrode is an ITO electrode, and the second common electrode and the data line are both opaque metal electrodes.

6: The liquid crystal display panel according to claim 1, wherein the liquid crystal display panel further includes a color resist layer, and the color resist layer is sandwiched between the passivation layer and the planarization layer;
wherein a via hole is formed in the planarization layer and the passivation layer, and the color resist layer and the via hole is further staggered with the data line, and the outermost first common electrode is electrically connected to the second common electrode through the via hole.

7: The liquid crystal display panel according to claim 1, wherein the liquid crystal display panel further includes a BPS material layer, and the BPS material layer is located on the planarization layer and covering at least a portion of the first common electrode.

8: A liquid crystal display panel, comprising:
an array substrate;
a passivation layer disposed on the array substrate; and
a planarization layer disposed on the passivation layer;
wherein the planarization layer is provided with multiple first common electrodes, and the array substrate is provided with a second common electrode for shielding light, and the second common electrode is located at an edge location of an active area region of the liquid crystal display panel, the second common electrode extends to an inner side and/or an outer side of the active area region, and an outermost first common electrode of the multiple first common electrodes and the second common electrode are electrically connected;
wherein the array substrate includes a glass substrate and a gate insulation layer and the second common electrode on the glass substrate, the gate insulation layer covers the second common electrode; and multiple data lines are disposed on the gate insulation layer, and the passivation layer covers the multiple data lines; an outermost data line of the multiple data lines are located at the edge location of the active area region;
wherein the second common electrode that shields light is located below the outermost data line and the outermost first common electrode that transmits light is located above the outermost data line such that the second common electrode that shields light and the outermost first common electrode that transmits light are respectively located at two opposite sides of the outermost data line;
wherein the liquid crystal display panel further includes an upper substrate common electrode disposed opposite to the first common electrode, and a liquid crystal is sandwiched between the upper substrate common electrode and the first common electrode;
wherein the liquid crystal display panel further includes a color resist layer, and the color resist layer is sandwiched between the passivation layer and the planarization layer; and
wherein a via hole is formed in the planarization layer and the passivation layer, and the via hole is further staggered with the data line, and the outermost first common electrode is electrically connected to the second common electrode through the via hole.

9: The liquid crystal display panel according to claim 8, wherein a projection of the outermost data line on the glass substrate is a first projection, and a projection of the second common electrode below the outermost data line on the glass substrate is a second projection, the first projection is partially overlapped with the second projection portion in a width direction of the first projection, or the first projection is entirely inside the second projection in the width direction of the first projection.

10: The liquid crystal display panel according to claim 9, wherein the array substrate is provided with multiple scanning lines, and the liquid crystal display panel includes multiple second common electrodes; two opposite second common electrodes are disposed between adjacent two scanning lines; the second common electrode between the adjacent two scanning lines is located below the outermost data line; and in the array substrate, outermost of the multiple scanning lines is provided with two second common electrodes, a region surrounded by the multiple second common electrodes surrounds the active area region; wherein the second common electrode and the scanning line are insulated from each other.

11: The liquid crystal display panel according to claim 9, wherein the first common electrode is an ITO electrode, and the second common electrode and the data line are both opaque metal electrodes.

12: The liquid crystal display panel according to claim 8, wherein the liquid crystal display panel further includes a BPS material layer, and the BPS material layer is located on the planarization layer and covering at least a portion of the first common electrode.

13: A liquid crystal display panel, comprising:
an array substrate;
a passivation layer disposed on the array substrate; and
a planarization layer disposed on the passivation layer;
wherein the planarization layer is provided with multiple first common electrodes, and the array substrate is provided with a second common electrode for shielding light, and the second common electrode is located at an edge location of an active area region of the liquid crystal display panel, the second common electrode extends to an inner side and/or an outer side of the active area region, and an outermost first common electrode of the multiple first common electrodes and the second common electrode are electrically connected;
wherein the array substrate includes a glass substrate and a gate insulation layer and the second common electrode on the glass substrate, the gate insulation layer covers the second common electrode; and multiple data lines are disposed on the gate insulation layer, and the passivation layer covers the multiple data lines; an outermost data line of the multiple data lines is located at the edge location of the active area region;
wherein the second common electrode that shields light is located below the outermost data line and the outermost first common electrode that transmits light is located above the outermost data line such that the second common electrode that shields light and the outermost first common electrode that transmits light are respectively located at two opposite sides of the outermost data line;
wherein the liquid crystal display panel further includes a color resist layer and a BPS material layer;
wherein the liquid crystal display panel further includes a color resist layer, and the color resist layer is sandwiched between the passivation layer and the planarization layer;
wherein a via hole is formed in the planarization layer and the passivation layer, and the via hole is further staggered with the data line, and the outermost first common electrode is electrically connected to the second common electrode through the via hole; and
wherein the BPS material layer is located on the planarization layer and covering at least a portion of the first common electrode.

14: The liquid crystal display panel according to claim 13,
wherein the liquid crystal display panel further includes an upper substrate common electrode disposed opposite to the first common electrode, and a liquid crystal is sandwiched between the upper substrate common electrode and the first common electrode.

15: The liquid crystal display panel according to claim 14, wherein a projection of the outermost data line on the glass substrate is a first projection, and a projection of the second common electrode below the outermost data line on the glass substrate is a second projection, the first projection is partially overlapped with the second projection portion in a width direction of the first projection, or the first projection is entirely inside the second projection in the width direction of the first projection.

16: The liquid crystal display panel according to claim 15, wherein the array substrate is provided with multiple scanning lines, and the liquid crystal display panel includes multiple second common electrodes; two opposite second common electrodes are disposed between adjacent two scanning lines; the second common electrode between the adjacent two scanning lines is located below the outermost data line; and in the array substrate, outermost of the multiple scanning lines is provided with two second common electrodes, a region surrounded by the multiple second common electrodes surrounds the active area region; wherein the second common electrode and the scanning line are insulated from each other.

17: The liquid crystal display panel according to claim 15, wherein the first common electrode is an ITO electrode, and the second common electrode and the data line are both opaque metal electrodes.
